(19) United States
(12) Patent Application Publication
(10) Pub. No.: US 2018/0261188 A1
(43) Pub. Date: Sep. 13, 2018

(54) DISPLAY PROCESSING METHOD AND APPARATUS, AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Luqiang GUO, Beijing (CN); Weihao HU, Beijing (CN); Wei HAO, Beijing (CN); Rui GUO, Beijing (CN); Jinhui CHENG, Beijing (CN); Chao ZHANG, Beijing (CN); Zhiming MENG, Beijing (CN); Boxiao LAN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/528,935

(22) PCT Filed: Oct. 12, 2016
(86) PCT No.: PCT/CN2016/101909

§ 371 Date: May 23, 2017

(30) Foreign Application Priority Data
Oct. 27, 2015 (CN) 201510705725.5

(51) Int. Cl. G09G 5/10; G09G 3/20

(52) U.S. Cl. CPC G09G 5/10; G09G 3/2092; G09G 2330/10; G09G 2320/0233; G09G 2320/0693

(57) ABSTRACT

The present disclosure discloses a method and a display processing apparatus and a display device. The display processing method of the present disclosure for a display device, of which a display region includes a non-uniform display region, includes a time obtaining step of obtaining an operating time of the display device from a start time of the display device, and a data converting step of determining target display data for a to-be-compensated subpixel in the non-uniform display region based on the operating time.

### CROSS-REFERENCE TO RELATED APPLICATIONS

The present application claims a priority of the Chinese Patent Application No. 201510705725.5 filed in China on Oct. 27, 2015 and titled “Display Processing Method and Device, and Display Device”, which is incorporated herein by reference in its entirety.

### TECHNICAL FIELD

The present disclosure relates to the field of display technology, in particular to a display processing method and a display processing apparatus and a display device.

### BACKGROUND

Manufacture of various types of flat displays involves numerous processes. For example, manufacture of a liquid crystal panel in a liquid crystal flat display involves complex processes and materials in connection with a backlight module, a polarizing film and a brightness enhancement film, a glass substrate laminating process, etc. If a small defect occurs during a certain process in the manufacture, there may be a non-uniform display region that appears as a bright spot, a dark spot, a bright region, a dark region, etc. in a final lighting test.

The non-uniform display region may have a wide variety of shapes, e.g. a lateral stripe shape, a forty-five degree stripe shape, a block shape or other irregular shapes.

The non-uniform display region may affect users' visual. Reduction in the occurrence of the non-uniform display region can be achieved by improving materials, processes, formulas, manufacturing procedures, etc. However, the above solution would complicate the manufacture.

In view of the above, there is also a technical solution for improving display non-uniformity by means of signal processing, including steps as follows: capturing an image of the display panel in a steady state; analyzing the image to determine features such as position, non-uniformity type and brightness differences for each subpixel in the non-uniform display region, and calculating a data driving signal compensation value based on the determined features; forming a compensation table recording the data driving signal compensation value for each subpixel in the non-uniform display region based on the above determined data driving signal compensation value.

During display, for each subpixel in the non-uniform display region, an original data driving signal corresponding to the subpixel is compensated for using the data driving signal compensation value for each subpixel in the non-uniform display region recorded in the compensation table.

However, the above-mentioned technical solution has a problem that the display non-uniformity compensation effect is poor, which is explained below.

In the technical solution for improving display non-uniformity by means of signal processing, at any given time point during display, compensation is performed based on a fixed compensation value, and thus the improvement in display non-uniformity is limited.

### SUMMARY

An object of embodiments of the present disclosure is to provide a display processing method and a display processing apparatus and a display device, so as to improve display non-uniformity.

To achieve the above object, the present disclosure discloses a display processing method for a display device. A display region of the display device includes a non-uniform display region. The display processing method includes: a time obtaining step of obtaining an operating time of the display device from a start time of the display device; and a data converting step of determining target display data for a to-be-compensated subpixel in the non-uniform display region based on the operating time obtained by the time obtaining module.

In an embodiment, the display processing method may further include: a subpixel determining step of determining a target subpixel, currently-received original display data being used for the target subpixel; and a flow controlling step of judging whether the target subpixel is located in the non-uniform display region to obtain a judgment result, and proceeding to the data converting step in response to the judgment result indicating that the target subpixel is located in the non-uniform display region and otherwise proceeding to an outputting step; and the outputting step of outputting the original display data.

In an embodiment, the data converting step may specifically include: a direction determining step of determining a compensation direction based on a non-uniformity type of the to-be-compensated subpixel; a coefficient determining step of determining a compensation coefficient for the to-be-compensated subpixel based on the operating time; a calculating step of determining a compensation amount based on the compensation coefficient and a predetermined compensation reference value for the to-be-compensated subpixel, wherein the compensation reference value for the to-be-compensated subpixel is a compensation value required for eliminating display non-uniformity of the to-be-compensated subpixel in the event that the display non-uniformity of the to-be-compensated is in a steady state; and a data compensating step of compensating for original display data of the to-be-compensated subpixel with the compensation amount in the compensation direction to obtain the target display data for the to-be-compensated subpixel.

In an embodiment, in the calculating step, a product of the compensation coefficient and the predetermined compensation reference value for the to-be-compensated subpixel may be calculated to obtain the compensation amount.

In an embodiment, a range of the operating time is divided into at least two consecutive time intervals, a compensation coefficient corresponding to a subsequent time interval is less than that corresponding to an antecedent time interval, and the coefficient determining step further includes: determining a target time interval where the operating time falls, wherein the target interval is one of the at least two consecutive time intervals; and determining a compensation coefficient corresponding to the target time interval as the compensation coefficient for the to-be-compensated subpixel based on a prestored correspondence between the time intervals and the compensation coefficients.

In an embodiment, a start point of a last time interval in the at least two consecutive time intervals is a time point in the event that an image displayed nonuniformly reaches a steady state, and the compensation coefficient corresponding to the last time interval is 1.

In an embodiment, the compensation coefficient decreases as the operating time increases.

In an embodiment, the data converting step further includes: a mapping step of selecting adjusted display data corresponding to the operating time and currently-received display data as the target display data based on a prestored correspondence for the to-be-compensated subpixel among time, before-adjustment display data and adjusted display data.

To achieve the above object, the present disclosure further discloses a display processing apparatus for a display device. A display region of the display device includes a non-uniform display region. The display processing apparatus includes: a time obtaining module, configured to an operating time of the display device from a start time of the display device; and a data converting module, configured to determine target display data for a to-be-compensated subpixel in the non-uniform display region based on the operating time.

In an embodiment, the above display processing apparatus may further includes: a subpixel determining module, configured to determine a target subpixel, currently-received original display data being used for the target subpixel; a flow controlling module, configured to judge whether the target subpixel is located in the non-uniform display region to obtain a judgment result, and trigger the data converting module in response to the judgment result indicating that the target subpixel is located in the non-uniform display region, and otherwise trigger an outputting module; and the outputting module, configured to output the original display data.

In an embodiment, the data converting module may include: a direction determining module, configured to determine a compensation direction based on a non-uniformity type of the to-be-compensated subpixel; a coefficient determining module, configured to determine a compensation coefficient for the to-be-compensated subpixel based on the operating time; a calculating module, configured to determine a compensation amount based on the compensation coefficient and a predetermined compensation reference value for the to-be-compensated subpixel, wherein the compensation reference value for the to-be-compensated subpixel is a compensation value required for eliminating display non-uniformity of the to-be-compensated subpixel in the event that the display non-uniformity of the to-be-compensated subpixel is in a steady state; and a data compensating module, configured to compensate for original display data of the to-be-compensated subpixel with the compensation amount in the compensation direction to obtain the target display data for the to-be-compensated subpixel.

In an embodiment, the calculating module is further configured to calculate a product of the compensation coefficient and the predetermined compensation reference value for the to-be-compensated subpixel to obtain the compensation amount.

In an embodiment, a range of the operating time is divided into at least two consecutive time intervals, a compensation coefficient corresponding to a subsequent time interval is less than that corresponding to an antecedent time interval, and the coefficient determining module is further configured to determine a target time interval where the operating time falls and determine a compensation coefficient corresponding to the target time interval as the compensation coefficient for the to-be-compensated subpixel based on a prestored correspondence between the time intervals and the compensation coefficients, wherein the target interval is one of the at least two consecutive time intervals.

In an embodiment, in the above processing device, a start point of a last time interval in the at least two consecutive time intervals is a time point in the event that an image displayed nonuniformly reaches a steady state, and a compensation coefficient corresponding to the last time interval is 1.

In an embodiment, the compensation coefficient decreases as the operating time increases.

In one example, in the above display processing apparatus, the data converting module further includes: a mapping module, configured to select adjusted display data corresponding to the operating time and currently-received display data as the target display data based on a prestored correspondence for the to-be-compensated subpixel among time, before-adjustment display data and adjusted display data.

To achieve the above object, the present disclosure further discloses a display device. A display region of the display device includes a non-uniform display region and a normal display region, wherein the display device includes any display processing apparatus described above.

In the embodiment of the present disclosure, the operating time is recorded after the display device is started. During a display process, original display data to be sent to the non-uniform display region is converted based on the operating time, and the target display data which is capable of compensating display non-uniformity corresponding to the current operating time is obtained. Compared to the related art, the method according to the embodiment of the present disclosure takes the time-variation characteristic of the display non-uniformity into consideration and thus has a better compensation effect on the display non-uniformity.

### BRIEF DESCRIPTION OF THE DRAWINGS

The accompanying drawings described hereinafter relate to only some embodiments of the present disclosure. Other drawings may be obtained by persons of ordinary skill in the art based on these accompanying drawings without any creative effort.

FIG. 1 is a schematic flowchart showing a display processing method according to the embodiments of the present disclosure.

FIG. 2 is a schematic flowchart showing another display processing method according to the embodiments of the present disclosure.

FIG. 3 is a schematic flowchart showing another display processing method according to the embodiments of the present disclosure.

FIG. 4 is a schematic flowchart showing another display processing method according to the embodiments of the present disclosure.

FIG. 5 is a schematic flowchart showing another display processing method according to the embodiments of the present disclosure.

FIG. 6 is a schematic structural diagram of a display processing apparatus according to the embodiments of the present disclosure.

FIG. 7 is a schematic structural diagram of another display processing apparatus according to the embodiments of the present disclosure.

FIG. 8 is a schematic structural diagram of another display processing apparatus according to the embodiments of the present disclosure.

FIG. 9 is a schematic structural diagram of another display processing apparatus according to the embodiments of the present disclosure.

FIG. 10 is a schematic structural diagram of another display processing apparatus according to the embodiments of the present disclosure.

### DETAILED DESCRIPTION

The present disclosure will be described hereinafter in a clear and complete manner in conjunction with the drawings and embodiments. Apparently, the following embodiments are merely a part of, rather than all of, the embodiments of the present disclosure. Based on these embodiments, other embodiments, which may be obtained by the persons of ordinary skills in the art without any creative effort, also fall within the scope of the present disclosure.

In a display processing method and a display processing apparatus and a display device of the embodiments of the present disclosure, based on a time-variation characteristic of the display non-uniformity, different compensation is given at different time points on the basis of a degree of display non-uniformity at the current time point.

As shown in FIG. 1, according to the embodiments of the present disclosure, a display processing method, for a display device of which a display region includes a non-uniform display region, includes following steps:

Time obtaining step 101, obtain an operating time of the display device from a start time of the display device.

Data converting step 102, determine target display data for a to-be-compensated subpixel in the non-uniform display region based on the operating time.

It should be noted that, in specific embodiments of the present disclosure, the non-uniform display region may be part of the display region or the entire display region. That is, the size of the non-uniform display region is not limited in the embodiments of the present disclosure.

In the embodiment of the present disclosure, the operating time is recorded after the display device is started. During a display process, original display data to be sent to the non-uniform display region is converted based on the operating time, and the target display data which is capable of compensating display non-uniformity and corresponds to a current operating time is obtained. Compared to the related art, the method according to the embodiment of the present disclosure takes the time-variation characteristic of the display non-uniformity into consideration and thus has a better compensation effect on display non-uniformity.

It should be understood that, the operating time mentioned above means cumulative operating time of the display device of this time. Once the display device stops operating (e.g., the display device is in a power-off state or in a sleep state so that the display device stops sending driving data to a display panel), the operating time is reset to zero.

It should be understood that the display device in the embodiments of the present disclosure may be various types of flat displays such as a liquid crystal display, a light emitting diode display, or a plasma display.

In the specific embodiments of the present disclosure, data conversion is implemented by two approaches as an example, one being a mapping approach and the other being a real-time calculation approach. The two approaches will be respectively described in detail below.

<Real-Time Calculation Approach>

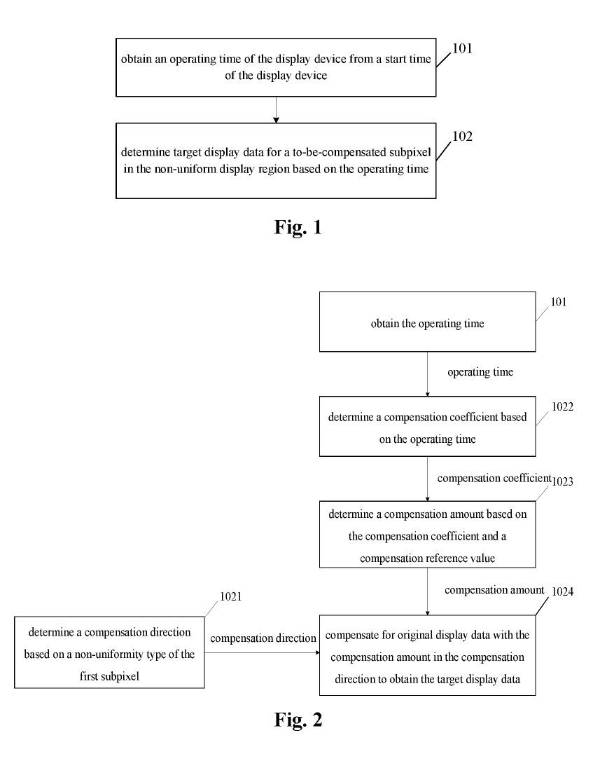

As shown in FIG. 2, according to the embodiments of the present disclosure, another display processing method includes following steps.

Time obtaining step 101, obtain an operating time of the display device from a start time of the display device.

Direction determining step 1021, determine a compensation direction based on a non-uniformity type of the to-be-compensated subpixel.

Coefficient determining step 1022, determine a compensation coefficient of the to-be-compensated subpixel based on the operating time.

Calculating step 1023, determine a compensation amount based on the compensation coefficient and a predetermined compensation reference value for the to-be-compensated subpixel, wherein the compensation reference value for the to-be-compensated subpixel is a compensation value that is required for eliminating display non-uniformity of the to-be-compensated subpixel when the image non-uniformity of the to-be-compensated subpixel is in a steady state.

Data compensating step 1024, compensate for original display data of the to-be-compensated subpixel with the compensation amount in the compensation direction to obtain the target display data for the to-be-compensated subpixel.

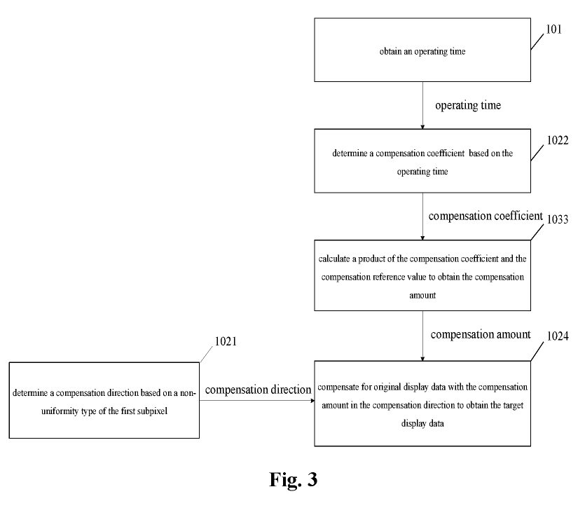

Optionally, as shown in FIG. 3, in calculating step 1033 (i.e., an example of the calculating step 1023 in FIG. 2), a product of the compensation coefficient and the predetermined compensation reference value for the to-be-compensated subpixel is calculated to obtain the compensation amount. The steps with the same reference numerals as those in FIG. 2 will not be repeated herein. It should be understood that, the present disclosure may also obtain the compensation amount through other relationships between the compensation coefficient and the compensation reference value. This will be explained in further detail as follows.

During the lighting test of the display panel, information such as the location, the category and the compensation reference value of the non-uniform display region of the display panel may be found out.

Generally, a subpixel is the minimum display unit of the display panel. In the specific embodiments of the present disclosure, a subpixel within the non-uniform display region is referred to as a display non-uniformity subpixel and a subpixel within a normal display region is referred to as a normal subpixel. The non-uniformity subpixel is compensated for only when the knowledge of its location is known, so location information is obtained in advance in the embodiments of the present disclosure.

The manufacture of various types of flat displays involves numerous processes. For example, the manufacture of a liquid crystal panel in a liquid crystal flat display involves complex processes and materials in connection with a backlight module a polarizing film and a brightness enhancement film, a glass substrate laminating process, etc. If a small defect occurs during a certain process in the manufacture, for a final lighting test, there may be a non-uniform display region that appears as a bright spot, a dark spot, a bright region, a dark region, etc. in a final lighting test. Distinction between the spot and the region is that the spot relates to one subpixel and the region includes a plurality of subpixels. Since compensation approaches required for the various types of the non-uniform display regions are different, the non-uniformity type of the subpixel is required to be obtained in advance.

Since compensations required for the various types of the non-uniform display regions are different (e.g., a relatively darker spot needs a larger compensation brightness), the compensation reference value for the display non-uniformity subpixel is also required to be obtained in advance.

Since liquid crystal molecules are sensitive to an electrical signal, display characteristic of the liquid crystal molecules may greatly change with the increase of a time period that a driving voltage is applied to the liquid crystal panel. These changes in the display non-uniformity phenomenon appear as follows: after the start, the display non-uniformity becomes weaker as the increase of the operation time, and finally tends to be stable. In other words, the display non-uniformity is more serious immediately after the start and becomes weaker as the operating time increases, and does not change after a period of time and is maintained at a certain level.

In the related art, the data driving signal compensation value is independent of time. Hence, when the data driving signal compensation value suitable for a stable stage may eliminate the display non-uniformity effectively in the stable stage, but it cannot completely eliminate the display non-uniformity before stabilization due to a higher non-uniformity degree.

Unlike the related art, in the specific embodiments of the present disclosure, a fixed compensation reference value is no longer used for compensation during the operation of the display device. An appropriate compensation coefficient is determined based on the operating time after the start of the display device, the compensation reference value is adjusted, a compensation amount that matches the non-uniformity degree of the current display non-uniformity pixel is obtained, and finally the adjusted compensation amount is used in the compensation.

As a result, in the embodiments of the present disclosure, the compensation for the display non-uniformity pixel matching its current non-uniformity degree has a better compensation effect on the display non-uniformity phenomenon.

As mentioned previously, the degree of the display non-uniformity gradually decreases as the operating time increases. Hence, in the specific embodiments of the present disclosure, when the degree of the display non-uniformity becomes lower (i.e., the operating time becomes longer), the compensation coefficient is reduced correspondingly. Optionally, the compensation coefficient may be a function of time, such as a step function or a continuous function. Two implementations of the compensation coefficient will be exemplarily described below.

In one implementation, the compensation coefficient varying over time is represented as a time-varying decreasing function ƒ(t) which is used for calculating a compensation coefficient corresponding to the operating time at any time. In other words, ƒ(t) is a decreasing function. For example, the compensation coefficient decreases as the operating time increases.

In the other implementation, a range of the operating time is divided into at least two consecutive time intervals, and a compensation coefficient corresponding to a subsequent time interval is less than that corresponding to an antecedent time interval. The coefficient determining step further includes as follows.

Determine a target time interval where the operating time falls, wherein the target interval is one of the at least two consecutive time intervals.

Determine a compensation coefficient corresponding to the target time interval as the compensation coefficient for the to-be-compensated subpixel in accordance with a prestored correspondence between the time intervals and coefficients.

In the at least two consecutive time intervals, values in a subsequent time interval are greater than value in an antecedent time interval.

For example, it is assumed that 15 minutes is required for the display non-uniformity to reach a steady state. A range of the operating time may be divided into 4 time intervals, where time interval 1 ranges from 0 to 5 minutes, time interval 2 ranges from 5 minutes to 10 minutes, time interval 3 ranges from 10 minutes to 15 minutes, and time interval 4 ranges from 15 minutes to infinity.

Correspondence between time intervals and the compensation coefficients is shown in the table below.

| Time interval | Compensation coefficient |
|---|---|
| time interval 1: start-5 minutes | A1 |
| time interval 2: 5-10 minutes | A2 |
| time interval 3: 10-15 minutes | A3 |
| time interval 4: after 15 minutes | A4 |

The compensation coefficients in the table should satisfy the relation: A1>A2>A3>A4=1. For example, A1=2.5, A2=2.0, A3=1.5, and A4=1.

Certainly, the values of the above time intervals and A1, A2, A3 and A4 are provided as examples only. More intervals may be defined to meet the requirement for a better improvement to the display non-uniformity, while fewer intervals may be defined to meet the requirement for a lower system complexity.

The specific compensation coefficients corresponding to time intervals may be obtained by experiments, which will not be described in detail herein.

It can be seen that, the start point of the last time interval is the time point when the image displayed nonuniformly reaches a steady state, and the compensation coefficient corresponding to the last time interval is 1.

In the above real-time calculation, only two sets of data (the coefficients and the compensation reference value corresponding to the subpixels) need to be pre-stored, thus requiring less storage space.

<Mapping Approach>

In the specific embodiments of the present disclosure, a compensation amount for each subpixel is calculated in real time. For each subpixel, the compensation coefficient is found based on the operating time, the compensation reference value for the subpixel is found, a product of the compensation coefficient and the compensation reference value is calculated to obtain the compensation amount, and the original display data is converted based on the compensation amount.

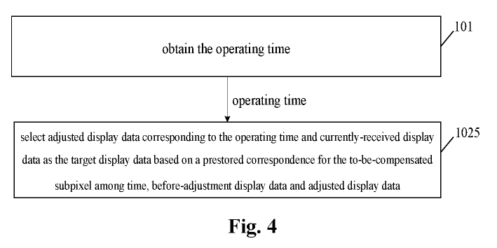

When there are more subpixels within the non-uniform display region, to reduce the amount of data calculation and improve the real time performance, another display processing method of the embodiments of the present disclosure as shown in FIG. 4 includes following steps.

Time obtaining step 101, obtain an operating time of the display device from a start time of the display.

Mapping step 1025, select adjusted display data corresponding to the operating time and currently-received display data as the target display data based on a prestored correspondence for the to-be-compensated subpixel among time, before-adjustment display data and adjusted display data.

In the embodiments, a product of the compensation coefficient and the compensation reference value is pre-calculated to obtain the compensation amount according to the embodiments shown in FIG. 2 or FIG. 3, the original display data is pre-calculated according to the compensation amount to obtain the target display data, and the correspondence among time, before-adjustment display data and the adjusted display data of the to-be-compensated subpixel is pre-stored.

During the operation, the target display data is determined by performing a search in the correspondence in accordance with the operating time and the original display data, so that the calculation amount is greatly reduced and the limited processing resources of a processer is saved.

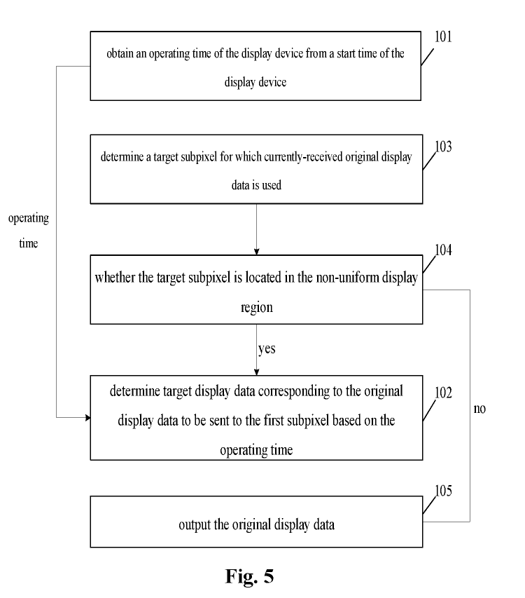

In the specific embodiments of the present disclosure, when a display region of the display device includes a non-uniform display region formed by the to-be-compensated subpixels and a normal region, no compensation process may be required for the normal region in any approach to ensure that “zero compensation operation” (in the implementation of a logic device, a certain time is required even if no compensation is required finally, e.g., one input of an adder is set to 0, the output is the same as the input in this case, that is, “zero compensation operation” is realized, and it takes time for this process) which consumes processing resources and time will not be performed in the data converting step for the original display data for the subpixels in the normal region. As shown in FIG. 5, according to the embodiments of the present disclosure, another display processing method includes following steps.

Time obtaining step 101, obtain an operating time of the display device from a start time of the display device.

Subpixel determining step 103, determine a target subpixel for currently-received original display data.

Flow controlling step 104, judge whether the target subpixel is located in the non-uniform display region to obtain a judgment result, and perform a data converting step 102 if the judgment result indicates that the target subpixel is located in the non-uniform display region, and otherwise perform an outputting step 105.

Data converting step 102, determine target display data for the original display data to be sent to a to-be-compensated subpixel based on the operating time.

Outputting step 105, output the original display data.

In the embodiment, the original display data for the subpixel within the normal region is directly output, thereby improving the processing speed.

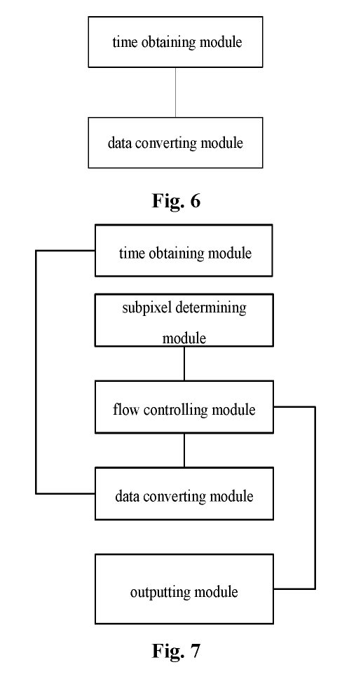

To achieve the above object, the embodiments of the present disclosure further provide a display processing apparatus for a display device of which a display region includes a non-uniform display region, includes a time obtaining module and a data converting module, as shown in FIG. 6.

The time obtaining module is configured to obtain an operating time of the display device from a start time of the display device.

The data converting module is configured to determine target display data for a to-be-compensated subpixel in the non-uniform display region based on the operating time obtained by the time obtaining module.

It should be noted that, in specific embodiments of the present disclosure, the non-uniform display region may be part of the display region or the entire display region.

In the embodiment, the operating time is recorded after the display device is started. During a display process, the original display data to be sent to the non-uniform display region is converted based on the operating time, and the target display data which is capable of compensating display non-uniformity and corresponds to a current operating time is obtained. Compared to the related art, the method according to the embodiment of the present disclosure takes the time-variation characteristic of the display non-uniformity into consideration and thus has a better compensation effect on display non-uniformity.

As show in FIG. 7, another display processing apparatus of the embodiment s of the present disclosure includes a time obtaining module, a subpixel determining module, a flow controlling module, an outputting module and a data converting module.

The time obtaining module is configured to obtain an operating time of the display device from a start time of the display device.

The subpixel determining module is configured to determine a target subpixel for which currently-received original display data is used.

The flow controlling module is configured to judge whether the target subpixel is located in the non-uniform display region to obtain a judgment result, and trigger the data converting module if the judgment result indicates that the target subpixel is located in the non-uniform display region, and otherwise trigger the outputting module.

The outputting module is configured to output the original display data.

The data converting module is configured to determine target display data corresponding to the original display data to be sent to the to-be-compensated subpixel based on the operating time.

In some embodiments, the original display data for the subpixel within the normal region is directly output, thereby improving the processing speed.

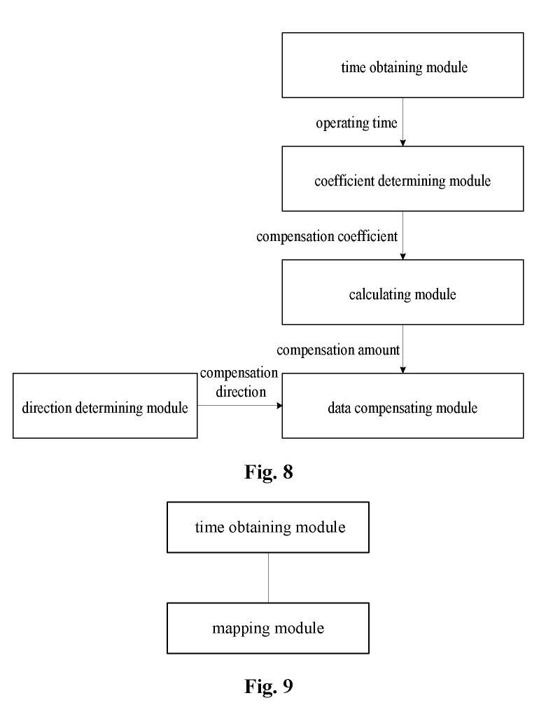

In some embodiments, in order to reduce data storage requirements, the data is converted in a real-time calculation way. In this case, as shown in FIG. 8, another display processing apparatus according to the embodiments of the present disclosure includes a time obtaining module, a direction determining module, a coefficient determining module, a calculating module and a data compensating module.

The time obtaining module is configured to obtain an operating time of the display device from a start time of the display device.

The direction determining module is configured to determine a compensation direction based on a non-uniformity type of the to-be-compensated subpixel.

The coefficient determining module is configured to determine a compensation coefficient of the to-be-compensated subpixel based on the operating time.

The calculating module is configured to determine a compensation amount based on the compensation coefficient and a predetermined compensation reference value for the to-be-compensated subpixel, wherein the compensation reference value for the to-be-compensated subpixel is a compensation value that is required for eliminating display non-uniformity of the to-be-compensated subpixel when the display non-uniformity of the to-be-compensated subpixel is in a steady state.

The data compensating module is configured to compensate for original display data of the to-be-compensated subpixel with the compensation amount in the compensation direction to obtain the target display data for the to-be-compensated subpixel.

Optionally, the calculating module may be configured to calculate a product of the compensation coefficient and the predetermined compensation reference value for the to-be-compensated subpixel to obtain the compensation amount.

In the above display processing apparatus, a range of the operating time is divided into at least two consecutive time intervals, a compensation coefficient corresponding to a subsequent time interval is less than that corresponding to an antecedent time interval, and the coefficient determining module is further configured to determine a target time interval where the operating time falls and determine a compensation coefficient corresponding to the target time interval as the compensation coefficient for the to-be-compensated subpixel in accordance with a prestored correspondence between the time intervals and coefficients, wherein the target interval is one of the at least two consecutive time intervals.

In the above display processing apparatus, the start point of the last time interval is the time point when the image displayed nonuniformly reaches a steady state, and the compensation coefficient corresponding to the last time interval is 1.

Optionally, the compensation coefficient may be represented as a decreasing function of time. For example, the compensation coefficient decreases as the operating time increases.

In the embodiments of the present disclosure, in order to improve the speed of data conversion, the data is converted in a mapping manner. In this case, the display processing apparatus as shown in FIG. 9 includes the above display processing apparatus, wherein the data converting module further includes a mapping module.

The mapping module is further configured to select adjusted display data corresponding to the operating time and the currently-received display data as the target display data in accordance with a prestored correspondence for the to-be-compensated subpixel among time, before-adjustment display data and adjusted display data.

To achieve the above object, the embodiments of the present disclosure further provide a display device of which a display region includes a non-uniform display region and a normal display region. The display device includes any display processing apparatus mentioned above.

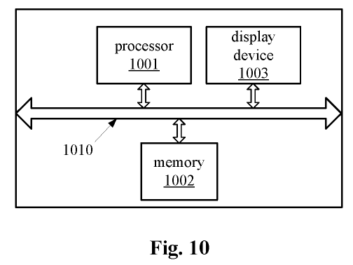

The method steps disclosed in the above embodiments may be implemented by the display processing apparatus as shown in FIG. 10 which includes a processor 1001 and a memory 1002. The processor 1001 controls operations of the display processing apparatus. The memory 1001 may include a random access memory or a random access memory, and provide instructions and data to the processor 1001. A portion of the memory 1002 may also include a non-volatile random access memory (NVRAM). The processor 1001, the memory 1002 and the display device 1003 may be coupled together by a bus system 1010, which may include a power bus, a control bus, and a status signal bus in addition to a data bus. However, for the sake of clarity, the various buses are illustrated in FIG. 10 as the bus system 1010.

The processor 1001 may be an integrated circuit chip and has the signal processing capability. In implementations, various steps in the above method may be achieved by hardware logic circuits or software instructions in the processor 1001. The processor 1001 may be a general purpose processor, including a central processing unit (CPU), a network processor (NP), etc, or may be a digital signal processor (DSP), an application Specific Integrated Circuit (ASIC), a field programmable gate array (FPGA) or other programmable logic devices. Various methods, steps and logic blocks disclosed in the present disclosure may be implemented or executed using discrete gate or transistor logics, discrete hardware components. The general purpose processor may be a microprocessor or may be any conventional processor.

In the embodiments of the present disclosure, the display region of the display device 1003 includes the non-uniform display region, and the processor 1001 performs the following steps by executing instructions or data stored in the memory 1002: obtaining an operating time of the display device from a start time of the display device; and determining target display data for a to-be-compensated subpixel in the non-uniform display region based on the operating time.

Specific examples may refer to the aforementioned embodiments and will not be repeated in detail herein.

In the embodiments of the present disclosure, modules may also be implemented in software for execution by various types of processors. For example, an identified executable code includes one or more physical or logical blocks of computer instructions and may be constructed as, for example, functions, procedures, and objects. Nevertheless, the executable code of the identified module need not be physically located together, but may include different instructions stored in different locations which, when combined logically together, constitute the module and achieve the stated purpose of the module.

Actually, an executable code module may include a single instruction or many instructions, and may be distributed over several different code segments, among different programs, and across multiple storage media. Likewise, operation data may be identified inside the module, may be realized in any appropriate form, and may be organized within any appropriate type of data structure. The operation data may be collected as a single data set, or may be distributed over different locations including over different storage devices, and may exist, at least partially, merely as electronic signals on a system or network.

When the modules may be realized by software, considering the technological level of hardware, the modules may be implemented in software and a person skilled in the art may design a corresponding hardware circuit to perform the corresponding functions without considering the costs. The hardware circuit including conventional very large scale integration (VLSI) circuits or gate arrays, existing semiconductors such as logic chips, transistors, or other discrete components. The modules may also be implemented in programmable hardware devices such as field programmable gate arrays, programmable array logic, or programmable logic devices.

Although the present disclosure has been described in the above with reference to the optional embodiments, the present disclosure is not limited thereto. It should be noted that, a person skilled in the art may make improvements and modifications without departing from the principle of the present disclosure, and these improvements and modifications shall also fall within the scope of the present disclosure as defined by the claims.

1. A display processing method for a display device, a display region of the display device comprising a non-uniform display region, the method comprising:
a time obtaining step of obtaining an operating time of the display device from a start time of the display device; and
a data converting step of determining target display data for a to-be-compensated subpixel in the non-uniform display region based on the operating time.

2. The method according to claim 1, wherein the data converting step further comprises:
a direction determining step of determining a compensation direction based on a non-uniformity type of the to-be-compensated subpixel;
a coefficient determining step of determining a compensation coefficient for the to-be-compensated subpixel based on the operating time;
a calculating step of determining a compensation amount based on the compensation coefficient and a predetermined compensation reference value for the to-be-compensated subpixel, wherein the compensation reference value for the to-be-compensated subpixel is a compensation value required for eliminating display non-uniformity of the to-be-compensated subpixel in the event that the display non-uniformity of the to-be-compensated is in a steady state; and
a data compensating step of compensating for original display data of the to-be-compensated subpixel with the compensation amount in the compensation direction to obtain the target display data for the to-be-compensated subpixel.

3. The method according to claim 2, wherein the calculating step further comprises:
calculating a product of the compensation coefficient and the predetermined compensation reference value for the to-be-compensated subpixel to obtain the compensation amount.

4. The method according to claim 2, wherein a range of the operating time is divided into at least two consecutive time intervals, a compensation coefficient corresponding to a subsequent time interval is less than that corresponding to an antecedent time interval, and the coefficient determining step further comprises:
determining a target time interval where the operating time falls, wherein the target interval is one of the at least two consecutive time intervals; and
determining a compensation coefficient corresponding to the target time interval as the compensation coefficient for the to-be-compensated subpixel based on a prestored correspondence between the time intervals and the compensation coefficients.

5. The method according to claim 4, wherein a start point of a last time interval in the at least two consecutive time intervals is a time point in the event that an image displayed nonuniformly reaches a steady state, and the compensation coefficient corresponding to the last time interval is 1.

6. The method according to claim 2, wherein the compensation coefficient decreases as the operating time increases.

7. The method according to claim 1, wherein the data converting step further comprises:
a mapping step of selecting adjusted display data corresponding to the operating time and currently-received display data as the target display data based on a prestored correspondence for the to-be-compensated subpixel among time, before-adjustment display data and adjusted display data.

8. The method according to claim 1, further comprising:
a subpixel determining step of determining a target subpixel, currently-received original display data being used for the target subpixel;
a flow controlling step of judging whether the target subpixel is located in the non-uniform display region to obtain a judgment result, and proceeding to the data converting step in response to the judgment result indicating that the target subpixel is located in the non-uniform display region and otherwise proceeding to an outputting step; and
the outputting step of outputting the original display data.

9. A display processing apparatus for a display device, a display region of the display device comprising a non-uniform display region, the display processing apparatus comprising:
a time obtaining module, configured to obtain an operating time of the display device from a start time of the display device; and
a data converting module, configured to determine target display data for a to-be-compensated subpixel in the non-uniform display region based on the operating time obtained by the time obtaining module.

10. The display processing apparatus according to claim 9, wherein the data converting module comprises:
a direction determining module, configured to determine a compensation direction based on a non-uniformity type of the to-be-compensated subpixel;
a coefficient determining module, configured to determine a compensation coefficient for the to-be-compensated subpixel based on the operating time;
a calculating module, configured to determine a compensation amount based on the compensation coefficient and a predetermined compensation reference value for the to-be-compensated subpixel, wherein the compensation reference value for the to-be-compensated subpixel is a compensation value required for eliminating display non-uniformity of the to-be-compensated subpixel in the event that the display non-uniformity of the to-be-compensated subpixel is in a steady state; and
a data compensating module, configured to compensate for original display data of the to-be-compensated subpixel with the compensation amount in the compensation direction to obtain the target display data for the to-be-compensated subpixel.

11. The display processing apparatus according to claim 10, wherein the calculating module is further configured to calculate a product of the compensation coefficient and the predetermined compensation reference value for the to-be-compensated subpixel to obtain the compensation amount.

12. The display processing apparatus according to claim 10, wherein a range of the operating time is divided into at least two consecutive time intervals, a compensation coefficient corresponding to a subsequent time interval is less than that corresponding to an antecedent time interval, and the coefficient determining module is further configured to determine a target time interval where the operating time falls and determine a compensation coefficient corresponding to the target time interval as the compensation coefficient for the to-be-compensated subpixel based on a prestored correspondence between the time intervals and the compensation coefficients, wherein the target interval is one of the at least two consecutive time intervals.

13. The display processing apparatus according to claim 12, wherein a start point of a last time interval in the at least two consecutive time intervals is a time point in the event that an image displayed nonuniformly reaches a steady state, and a compensation coefficient corresponding to the last time interval is 1.

14. The display processing apparatus according to claim 10, wherein the compensation coefficient decreases as the operating time increases.

15. The display processing apparatus according to claim 9, wherein the data converting module further comprises:
a mapping module, configured to select adjusted display data corresponding to the operating time and currently-received display data as the target display data based on a prestored correspondence for the to-be-compensated subpixel among time, before-adjustment display data and adjusted display data.

16. The display processing apparatus according to claim 9, further comprising:
a subpixel determining module, configured to determine a target subpixel, currently-received original display data being used for the target subpixel;
a flow controlling module, configured to judge whether the target subpixel is located in the non-uniform display region to obtain a judgment result, and trigger the data converting module in response to the judgment result indicating that the target subpixel is located in the non-uniform display region, and otherwise trigger an outputting module; and
the outputting module, configured to output the original display data.

17. A display device, a display region of the display device comprising a non-uniform display region and a normal display region, the display device comprising
a display processing apparatus, the display processing apparatus comprising:
a time obtaining module, configured to obtain an operating time of the display device from a start time of the display device; and
a data converting module, configured to determine target display data for a to-be-compensated subpixel in the non-uniform display region based on the operating time obtained by the time obtaining module.

18. The method according to claim 3, wherein a range of the operating time is divided into at least two consecutive time intervals, a compensation coefficient corresponding to a subsequent time interval is less than that corresponding to an antecedent time interval, and the coefficient determining step further comprises:
determining a target time interval where the operating time falls, wherein the target interval is one of the at least two consecutive time intervals; and
determining a compensation coefficient corresponding to the target time interval as the compensation coefficient for the to-be-compensated subpixel based on a prestored correspondence between the time intervals and the compensation coefficients.

19. The method according to claim 3, wherein the compensation coefficient decreases as the operating time increases.

20. The display processing apparatus according to claim 11, wherein a range of the operating time is divided into at least two consecutive time intervals, a compensation coefficient corresponding to a subsequent time interval is less than that corresponding to an antecedent time interval, and the coefficient determining module is further configured to determine a target time interval where the operating time falls and determine a compensation coefficient corresponding to the target time interval as the compensation coefficient for the to-be-compensated subpixel based on a prestored correspondence between the time intervals and the compensation coefficients, wherein the target interval is one of the at least two consecutive time intervals.
